(19) United States
(12) Patent Application Publication
(10) Pub. No.: US 2013/0106903 A1
(43) Pub. Date: May 2, 2013

(54) MOBILE TERMINAL DEVICE, STORAGE MEDIUM, AND METHOD FOR DISPLAY CONTROL OF MOBILE TERMINAL DEVICE

(71) Applicant: Kyocera Corporation, Kyoto (JP)

(72) Inventors: Shunsuke NAGATA, Osaka (JP); Keiko MIKAMI, Osaka (JP)

(73) Assignee: KYOCERA CORPORATION, Kyoto (JP)

(21) Appl. No.: 13/661,761

(22) Filed: Oct. 26, 2012

(30) Foreign Application Priority Data
Oct. 27, 2011 (JP) 2011-236372

(51) Int. Cl. G06T 5/00

(52) U.S. Cl. CPC G06T 5/00
USPC 345/619

(57) ABSTRACT

A mobile terminal device includes: a display surface; a storage module which stores data of a first image, data of a second image created from the first image, and relation data for relating the first image to the second image; and a display control module which displays on the display surface the first image and the second image in a form indicating that these images relate to each other.

This application claims priority under 35 U.S.C. Section 119 of Japanese Patent Application No. 2011-236372 filed Oct. 27, 2011, entitled “MOBILE TERMINAL DEVICE, PROGRAM, AND METHOD FOR DISPLAY CONTROL”. The disclosure of the above application is incorporated herein by reference.

### BACKGROUND OF THE INVENTION

1. Field of the Invention

The present invention relates to cellular phones, personal digital assistants (PDAs), tablet PCs, mobile terminal devices such as electronic book terminals, storage media holding computer programs preferably for use in the mobile terminal devices, and methods for display control of the mobile terminal devices.

2. Disclosure of Related Art

Conventionally, there is known a mobile terminal device that allows editing of images displayed on a display surface. For example, a predetermined processing operation is performed on an image to create a new image on the mobile terminal device (refer to Patent Document 1).

In general, a newly created image (post-editing image) is stored in a storage module such as a memory provided in the mobile terminal device. A user can display and view pre-editing and post-editing images and the like on the display surface of the mobile terminal device.

When a desired image is to be viewed, thumbnails of images are first displayed on the display surface. The user can select the desired image from a list of the thumbnails and view the selected image.

However, in the case a plurality of images including pre-editing and post-editing images is displayed on the display surface, the user needs to compare a plurality of displayed thumbnails to identify which of the images is a post-editing image created based on a pre-editing image. In addition, the user needs to compare the plurality of displayed thumbnails to identify which of the images is edited to create a post-editing image. This requires the user to perform troublesome tasks of identifying the pre-editing and post-editing images.

### SUMMARY OF THE INVENTION

A first aspect of the present invention relates to a mobile terminal device. The mobile terminal device according to this aspect includes: a display surface; a storage module which stores data of a first image, data of a second image created from the first image, and relation data for relating the first image to the second image; and a display control module which displays on the display surface the first image and the second image in a form indicating that these images relate to each other.

A second aspect of the present invention relates to a storage medium that holds a computer program applied to a mobile terminal device. The mobile terminal device includes a display surface for displaying an image. The computer program provides a computer of the mobile terminal device with a function of displaying on the display surface a first image and a second image created from the first image in a form indicating that these images relate to each other.

A third aspect of the present invention relates to a method for display control of a mobile terminal device including a display surface and a storage module. The method for display control according to this aspect includes the steps of: storing data of a first image, data of a second image created from the first image, and data for relating the first image to the second image, in the storage module; and displaying on the display surface the first image and the second image in a form indicating that these images relate to each other.

### BRIEF DESCRIPTION OF THE DRAWINGS

The foregoing and other objectives and novel features of the present invention will be more fully understood from the following description of preferred embodiments when reference is made to the accompanying drawings.

FIGS. 1A and 1B are diagrams showing an outer configuration of a cellular phone according to an embodiment of the present invention;

FIG. 2 is a block diagram showing an entire configuration of the cellular phone according to the embodiment;

FIG. 3A is a diagram showing one example of images stored in an image folder and FIGS. 3B and 3C are diagrams for describing configurations of file names of images, according to the embodiment;

FIGS. 4A and 4B are respectively a flowchart showing a process for storing a post-editing image in relation to a pre-editing image, and a diagram showing an example of establishing relations by specification of file names, according to the embodiment;

FIG. 5 is a flowchart showing a process for viewing an image, according to the embodiment;

FIGS. 6A and 6B are diagrams showing examples of a list screen for viewing images stored in the image folder and of a screen displayed on viewing of an image, according to the embodiment;

FIG. 7 is a flowchart showing a process for setting an image as a display target, according to the embodiment;

FIG. 8 is a diagram for describing relations between operations for changing images as display targets on viewing of the images and transitions of images displayed on the display surface, according to the embodiment;

FIGS. 9A to 9C are diagrams for describing a correlation chart screen for image(s) stored in the image folder, according to the embodiment;

FIG. 10 is a list screen for viewing images stored in the image folder, according to modification example 1;

FIG. 11 is a list screen for viewing images stored in the image folder, according to modification example 2;

FIG. 12A is a diagram showing one example of images stored in the image folder and FIGS. 12B to 12D are diagrams for describing configurations of file names of images, according to modification example 3;

FIG. 13 is a flowchart showing a process for storing a post-editing image in relation to a pre-editing image, according to modification example 3;

FIGS. 14A to 14C are diagrams showing examples of establishing relations by specification of file names, according to modification example 3;

FIG. 15 is a flowchart showing a process for setting an image as a display target, according to modification example 3;

FIG. 16 is a diagram for describing relations between operations for changing images as display targets on viewing of the images and transitions of images displayed on the display surface, according to modification example 3;

FIGS. 17A to 17C are diagrams for describing a correlation chart screen for image(s) stored in the image folder, according to modification example 3.

FIG. 18 is a diagram for describing relations between operations for changing images as display target on viewing of images and transition of images displayed on the display surface, according to modification example 4;

FIGS. 19A and 19B are diagrams showing display examples of screens providing relations between pre-editing and post-editing images, according to other modification examples; and

FIGS. 20A and 20B are diagrams showing display examples of screens providing relations between pre-editing and post-editing images, according to other modification examples.

However, the drawings are only for illustration and are not intended to limit the scope of the present invention.

### DESCRIPTION OF PREFERRED EMBODIMENTS

An embodiment of the present invention will be described below with reference to the drawings.

In this embodiment, a CPU 100 corresponds to a “display control module” recited in the claims. A memory 101 corresponds to a “storage module” recited in the claims. A touch sensor 12 and the CPU 100 constitute an “operation detection module” recited in the claims. However, the foregoing correspondence between the claims and the description of the embodiment is merely one example and does not limit the claims to the embodiment.

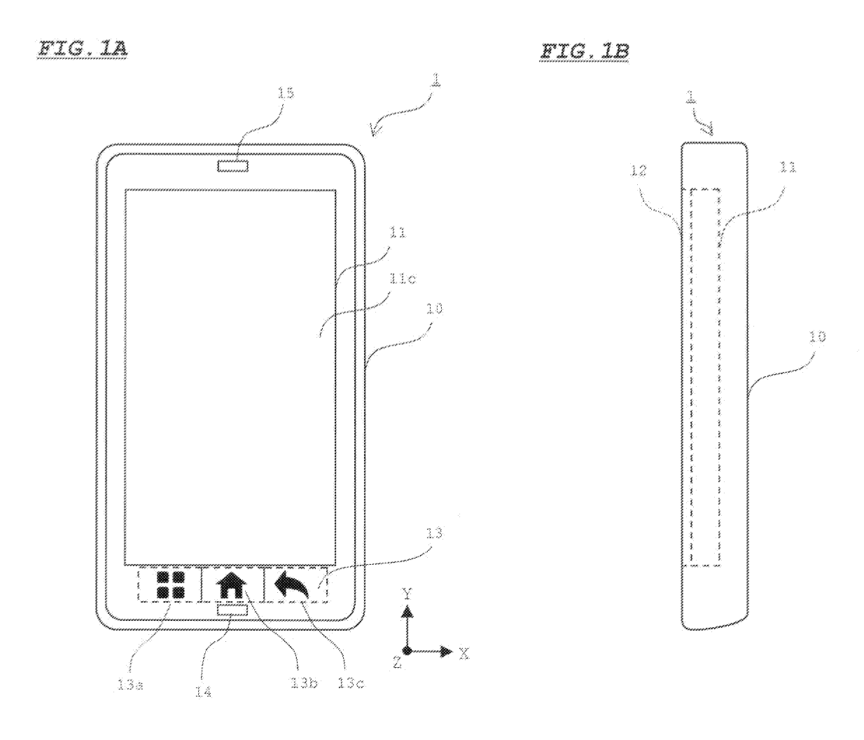

FIGS. 1A and 1B are diagrams showing an outer configuration of a cellular phone 1. FIGS. 1A and 1B are a front view and a side view, respectively.

The cellular phone 1 has a rectangular cabinet 10 with a small thickness. The cabinet 10 has a touch panel on a front side thereof. The touch panel includes a display 11 and a touch sensor 12 laid on the display 11.

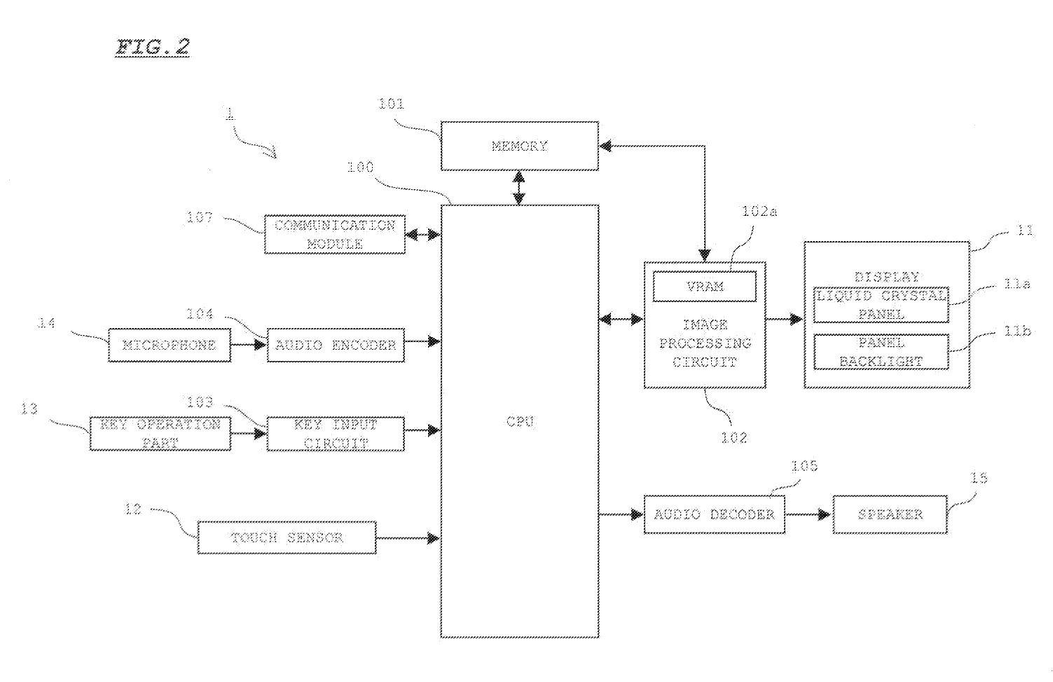

The display 11 is a liquid crystal display which is formed by a liquid crystal panel 11a and a panel backlight 11b illuminating the liquid crystal panel 11a as described later (refer to FIG. 2). The liquid crystal panel 11a has a display surface 11c for displaying images, and the display surface 11c is exposed to outside.

The display 11 is not limited to a liquid crystal display but may be any other display device such as an organic EL display.

The touch sensor 12 is arranged on the display surface 11c and detects an input position on the display surface 11c. The touch sensor 12 is formed as a transparent sheet, and a user can see the display surface 11c through the touch sensor 12.

The touch sensor 12 is a capacitance-type touch sensor which includes first transparent electrodes and second transparent electrodes which are aligned in a matrix, and a cover. The touch sensor 12 detects a position contacted by a user on the display surface 11c as an input position by sensing a change in capacitance between the first transparent electrodes and the second transparent electrodes. The touch sensor 12 outputs a position signal according to the input position. Contacting the display surface 11c actually refers to contacting a region on a surface of a cover covering the touch sensor 12, corresponding to the display surface 11c.

The user can perform various operations such as touching, tapping, flicking, sliding, or the like, by contacting the display surface 11c with the use of his/her finger or a contact member such as a pen, etc (hereinafter, referred to as simply “finger”). The “touching” here means an operation of contacting the display surface 11c by a finger. The “tapping” here means an operation of contacting the display surface 11c by a finger and then releasing (taking the finger off) the display surface 11c. The “flicking” here means an operation of contacting the display surface 11c by a finger and making a fillip (moving the contacting finger at a predetermined speed and taking the finger off). The “sliding” here means an operation of contacting the display surface 11c by a finger and holding and moving the finger by a predetermined distance and then taking the finger off from the touch panel.

The touch sensor 12 is not limited to a capacitance-type touch sensor 12 but may be any other touch sensor 12 of ultrasonic type, pressure-sensitive type, resistance film-type, light detecting-type, or the like.

The touch panel has a key operation part 13 including a home key 13a, a setting key 13b, and a back key 13c at a lower part of the touch panel (in a Y-axis negative direction). Specifically, the home key 13a is mainly designed to display the home screen on the display surface 11c. The setting key 13b is mainly designed to display a setting screen for making various settings on the display screen 11c. The back key 13c is mainly designed to return a screen on the display surface 11c to the one step previous step.

The cabinet 10 has on a front side thereof a microphone 14 at a lower part and a speaker 15 at an upper part. The user can conduct communications by listening to voices of a conversational partner from the speaker 15 and letting out his/her voices to the microphone 14.

FIG. 2 is a block diagram showing an entire configuration of the cellular phone 1. In addition to the foregoing components, the cellular phone 1 includes the CPU 100, a memory 101, an image processing circuit 102, a key input circuit 103, an audio encoder 104, an audio decoder 105, and a communication module 107.

The image processing circuit 102 generates images to be displayed on the display 11 according to control signals input from the CPU 100, and stores image data in a VRAM 102a of the image processing circuit 102.

The image processing circuit 102 outputs image signals containing the image data stored in the VRAM 102a, to the display 11. The image processing circuit 102 also outputs control signals for controlling the display 11 to turn on or off the panel backlight 11b of the display 11. Accordingly, light emitted from the backlight 11b is modulated by the liquid crystal panel 11a according to the image signals, whereby the images are displayed on the display surface 11c of the display 11.

The key input circuit 103, when any of the keys 13a to 13c constituting the key operation part 13 is pressed, outputs a signal corresponding to the pressed key to the CPU 100.

The audio encoder 104 converts audio signals output from the microphone 14 according to collected sounds, into digital audio signals, and outputs the digital audio signals to the CPU 100.

The audio decoder 105 subjects the audio signals from the CPU 100 to a decoding process and D/A conversion, and outputs the converted analog audio signals to the speaker 15.

The communication module 107 includes an antenna transmitting and receiving radio waves for telephone calls and telecommunications. The communication module 107 converts signals for phone calls and communications input from the CPU 100 into radio signals, and transmits via the antenna the converted radio signals to the other end of communications such as a base station or another communication device, etc. The communication module 107 also converts the radio signals received via the antenna into signals in a form that allows the CPU 100 to utilize the signal, and outputs the converted signals to the CPU 100.

The memory 101 includes a ROM and a RAM. The memory 101 stores control programs for providing the CPU 100 with control functions, and various applications. For example, the memory 101 stores various applications for phone calls, e-mail, web browser, music player, image viewing, image editing, and the like.

The memory 101 is also used as a working memory that stores various kinds of data temporarily used or generated during execution of an application.

In addition, the memory 101 stores images including photographed images, images acquired via a communication network, in a predetermined folder (hereinafter, referred to as “image folder”) on a file system structured in the memory 101 or the like. On viewing of images, the CPU 100 displays images stored in the image folder on the display surface 11c, according to an application for image viewing (as described later).

The CPU 100 controls components such as the microphone 14, the communication module 107, the display 11, and the speaker 15, according to the control programs, thereby to execute various applications.

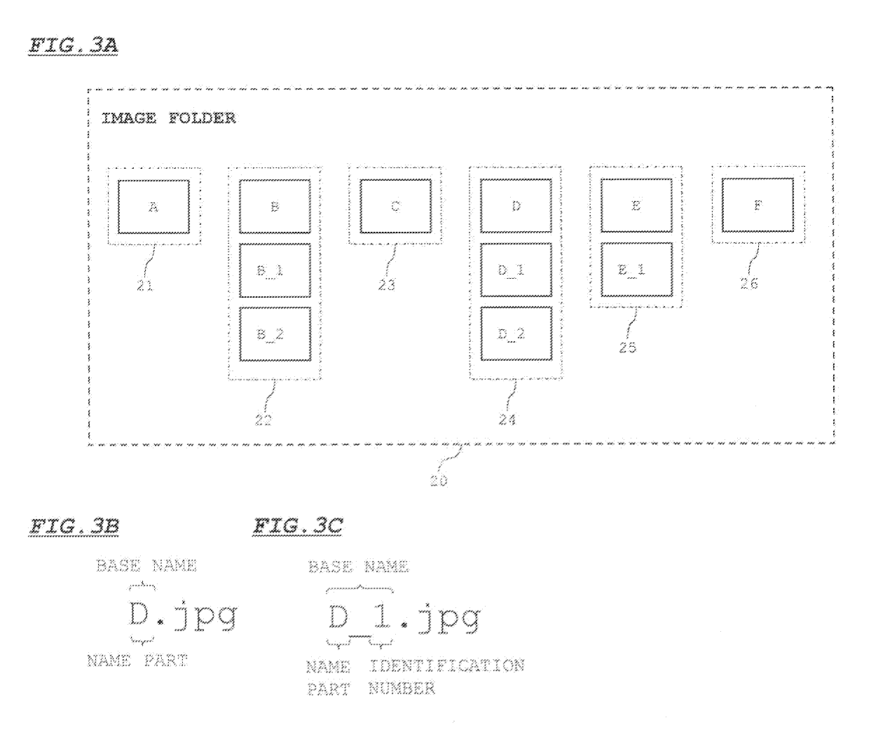

FIG. 3A is a diagram showing one example of images stored in the image folder 20. In FIG. 3A, the image folder 20 stores 11 images A, B, B_{—}1, B_{—}2, C, D, D_{—}1, D_{—}2, E, E_{—}1, and F.

The 11 images A, B, B_{—}1, B_{—}2, C, D, D_{—}1, D_{—}2, E, E_{—}1, and F are stored in the image folder 20, under file names A.jpg, B.jpg, B_{—}1.jpg, B_{—}2.jpg, C.jpg, D.jpg, D_{—}1.jpg, D_{—}2.jpg, E.jpg, E_{—}1.jpg, and F.jpg, respectively.

FIGS. 3B and 3C are diagrams for describing structures of file names.

The filenames of the 11 images each includes an extension “jpg” indicating a file format of the image, and a period “.” for identifying the extension part and the other part in the file name. File formats for the images stored in the image folder 20 include file formats other than jpg, such as gif, png, etc.

Embedded in each of the file names of the images stored in the image folder 20 is information indicating relations between pre-editing and post-editing images in a manner described below.

Base name (the part other than the period and the extension “jpg”) of the file name of each of the images stored in the image folder 20 may contain one underline “_”. The base name is divided into a “name part” before the underline “_” and an “identification number” after the underline “_”. The identification number is a positive integer. In the case the base name does not contain the underline “_”, the entire base name constitutes the name part.

For example, as shown in FIG. 3B, the file name “D.jpg” of the image D includes the base name “D” formed only by the name part, but does not include an identification number. In addition, as shown in FIG. 3C, the file name “D_{—}1.jpg” of the image D_{—}1 includes the base name “D_{—}1” formed by the name part “D” and the identification number “1”.

The images stored in the image folder 20 can be classified according to the name parts contained in the file names. In the example shown in FIG. 3A, the 11 images stored in the image folder 20 are classified into six groups of A group 21 to F group 26 (see frames of dashed lines).

The A group 21 is formed only by the image A with the name part “A” of the file name. The B group 22 is formed by the three images B, B_{—}1, and B_{—}2 each with the name part “B” of the file name. The C group 23 is formed only by the image C with the name part “C” of the file name. The D group 24 is formed by the three images D, D_{—}1, and D_{—}2 each with the name part “D” of the file name. The E group 25 is formed by the two images E and E_{—}1 each with the name part “E” of the file name. The F group 26 is formed only by the image F with the name part “F” of the file name.

Each of the groups 21 to 26 includes one image (hereinafter, referred to as “root image”) with a base name formed only by the name part, that is, one image with a file name not containing any identification number.

The root images are unedited images such as photograph images taken using the cellular phone 1 or images obtained via wired or wireless communication line networks. Meanwhile, the images with identification numbers are images newly created by editing the root images in the groups to which the images belong.

Referring to FIGS. 3A to 3C, images created by editing a root image (for example, the image D) are all of images (that is, D_{—}1 and D_{—}2) with file names in which identification numbers are added to the file name of the root image (refer to FIG. 3B). In addition, the root image of a non-root image (for example, image D_{—}1. Refer to FIG. 3C) is an image with a file name in which the identification number is removed from the file name of the non-root image (for example, the image D).

As described above, embedded in the file names of the images is information indicative of relations between pre-editing and post-editing images.

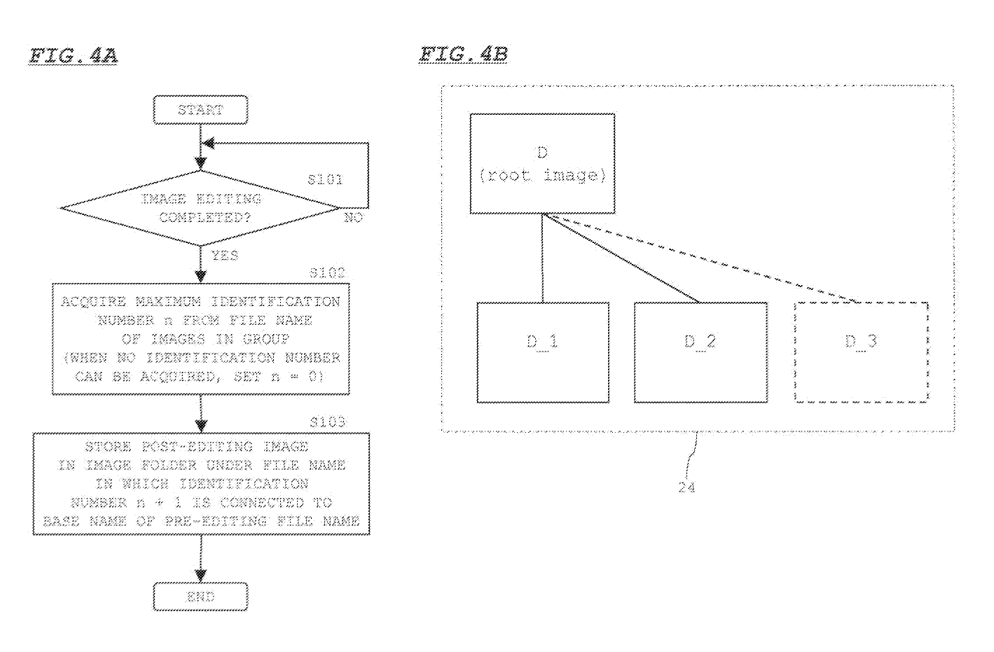

FIG. 4A is a flowchart showing a process for storing a post-editing image newly created by editing an image in the image folder 20, under a predetermined file name. FIG. 4B is a diagram showing an example of setting file names of images newly created according to the process shown in FIG. 4A. In FIG. 4B, lines connecting the image D as a root image and the images D_{—}1 and D_{—}2 indicate that these images are in the relations between pre-editing and post-editing images.

In the flowchart of FIG. 4A, when editing of an image belonging to one group is completed (S101: YES), the CPU 100 acquires a maximum identification number n from the file names of the images belonging to the group (S102). In the case no identification number can be acquired, that is, in the case the group includes only the root image before editing, the CPU 100 sets n=0 (S102).

Then, the CPU 100 stores the post-editing image in the image folder 20 under a file name in which the number n+1 as an identification number is added subsequent to the name part of the pre-editing file name (S103). On storage of the image, the CPU 100 inserts the underline “_” between the base name and the identification number n+1, and adds an extension (“.jpg” or the like) after the identification number, according to the file format of the post-editing image.

For example, when any of the three images D, D_{—}1, and D_{—}2 belonging to the D group 24 (refer to FIG. 3A) is edited, the CPU 100 acquires the maximum identification number n=2 in the D group 24 (S102). Accordingly, the post-editing image (the file format is set to “.jpg”, for example) is stored in the image folder 20, under the file name “D_{—}3.jpg”, as shown in FIG. 4B.

In addition, when the image A belonging to the A group 21 (refer to FIG. 3A) is edited, the CPU 100 sets the number n=0 at step S102. Accordingly, data of the post-editing image (in jpg format, for example) is stored in the image folder 20 under the file name “A_{—}1.JPG”.

As in the foregoing, the file name including data (relations data) indicative of a relation between a root image as a pre-editing image and a post-editing image is specified according to the process shown in FIG. 4A. Accordingly, the data indicative of the relation is stored in the memory 101 together with data of the post-editing image.

As in the foregoing, by referring to the name parts and the identification numbers of the file names, it is possible to identify the images with the common name part “D” and the identification numbers, that is, the post-editing images D_{—}1 to D_{—}3, from the root image D as a pre-editing image. In reverse, it is possible to identify the pre-editing image D as a root image from the post-editing images D_{—}1 to D_{—}3.

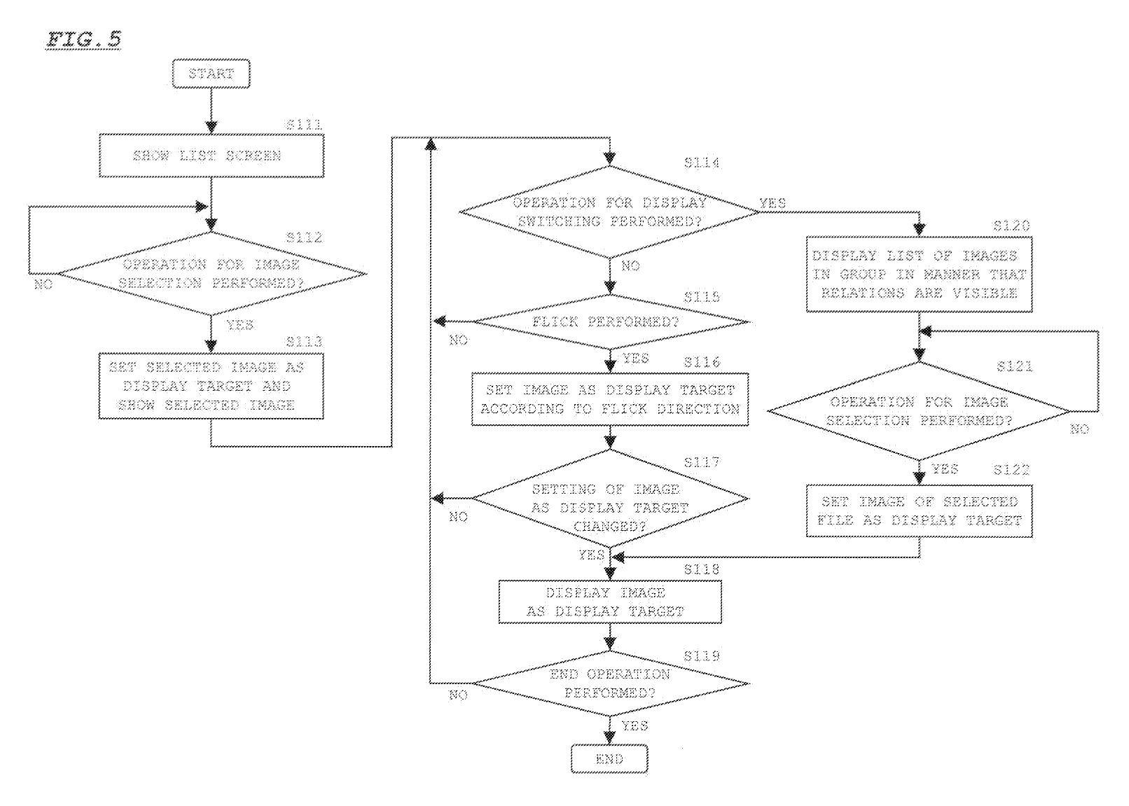

FIG. 5 is a flowchart showing a process for viewing an image stored in the image folder 20. When the touch sensor 12 detects a predetermined operation for viewing the image, the CPU 100 starts execution of the process shown in FIG. 5. The CPU 100 first displays a list screen 201 on the display surface 11c (S111).

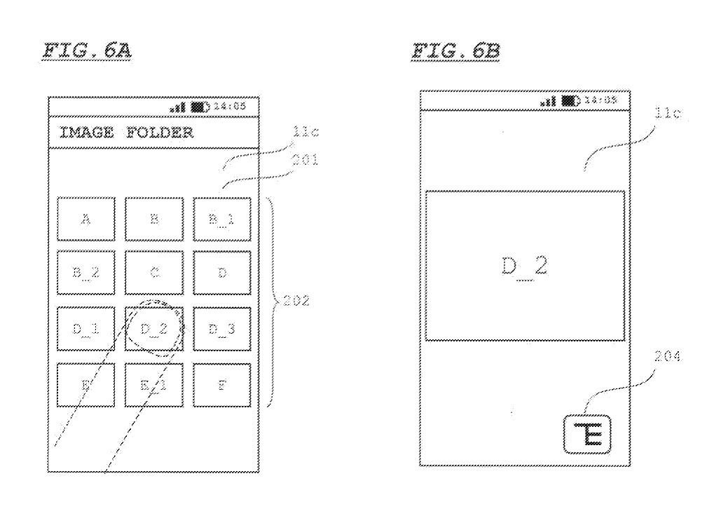

FIG. 6A is a diagram showing the list screen 201 displayed on the display surface 11c according to the process of FIG. 5. Shown in the list screen 201 are thumbnails 202 of the images stored in the image folder 20.

FIG. 6B is a diagram showing an image displayed on the display surface 11c according to the process shown in FIG. 5.

While the list screen 201 is displayed on the display surface 11c as shown in FIG. 6A, when an operation for selecting one image is performed, for example, when the touch sensor 12 detects an operation of tapping the thumbnail 202 of an image to be viewed (S112: YES), the CPU 100 displays the selected image on the display surface 11c (S113). For example, when the image D_{—}2 is selected in the list screen 201 (see a finger shown in FIG. 6A), the image D_{—}2 is displayed on the display surface 11c as shown in FIG. 6B.

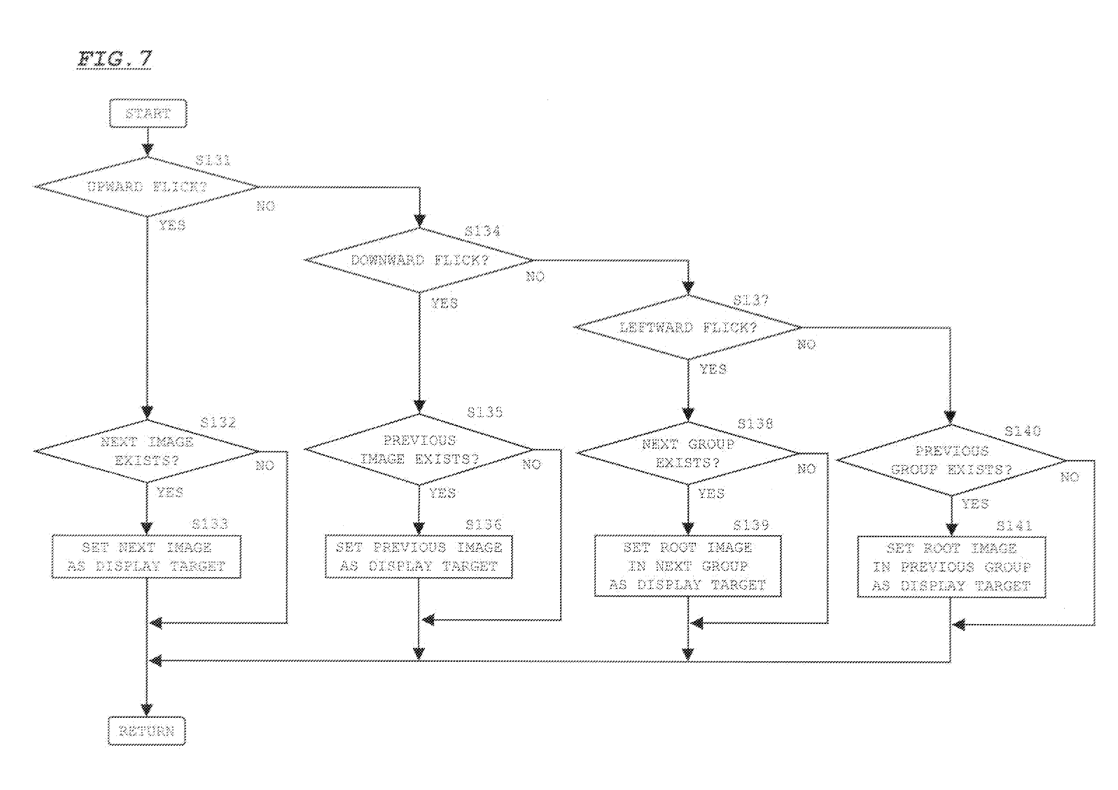

In the case the operation for switching the screens (pressing the button 204) is not performed (S114: NO), the CPU 100 determines whether the touch sensor 12 has detected a flick (S115). In the case the touch sensor 12 has detected a flick (S115: YES), the CPU 100 determines whether the direction of the flick is upward, downward, rightward, or leftward, and sets an image identified by the direction of the detected flick, as a next display target, according to the process shown in FIG. 7 described later (S116). When the image as a next display target is set, the set image is to be displayed on the display surface 11c at step S118.

In the case no change is made to the setting of the image as a display target in the process of FIG. 7 (S117: NO), the process returns to step S114. In the case the image as a display target is changed according to the setting made at step S116 (S117: YES), the CPU 100 displays the image newly set as a display target on the display surface 11c (S118).

The foregoing step S116 is performed as described below.

FIG. 7 is a flowchart showing a process (step S116) for setting the image as a display target. The flowchart of FIG. 7 shows a process for, with reference to an image as a current display target, setting as a display target the next image, the previous image, the root image in the next group, or the root image in the previous group, according to the direction of a flick.

For example, when the image D_{—}2 is regarded as a reference, the next image is the image D_{—}3 created as described above with reference to FIG. 4B, and the previous image is the image D_{—}1. In addition, the root image in the next group is the image E, and the root image in the previous group is the image C.

Specifically, the next image, the previous image, the next group, and the previous group are specified as described below.

The image(s) belonging to each of the groups 21 to 26 are given a predetermined sequence, and the “next image” and “previous image” are specified according to this sequence. In the sequence, the root image comes first. The image(s) other than the root image are given a sequence according to the identification numbers of the images, that is, the identification numbers included in the file names of the images. Accordingly, the image(s) belonging to each of the groups 21 to 26 are given a sequence in which the images are aligned from top down shown in FIG. 3A. For example, the B group 22 is given the sequence of the image B, image B_{—}1, and image B_{—}2.

In addition, each of the groups 21 to 26 is given a sequence according to alphabets (or character codes) concerning file names, and the “next group” and the “previous group” are specified according to this sequence.

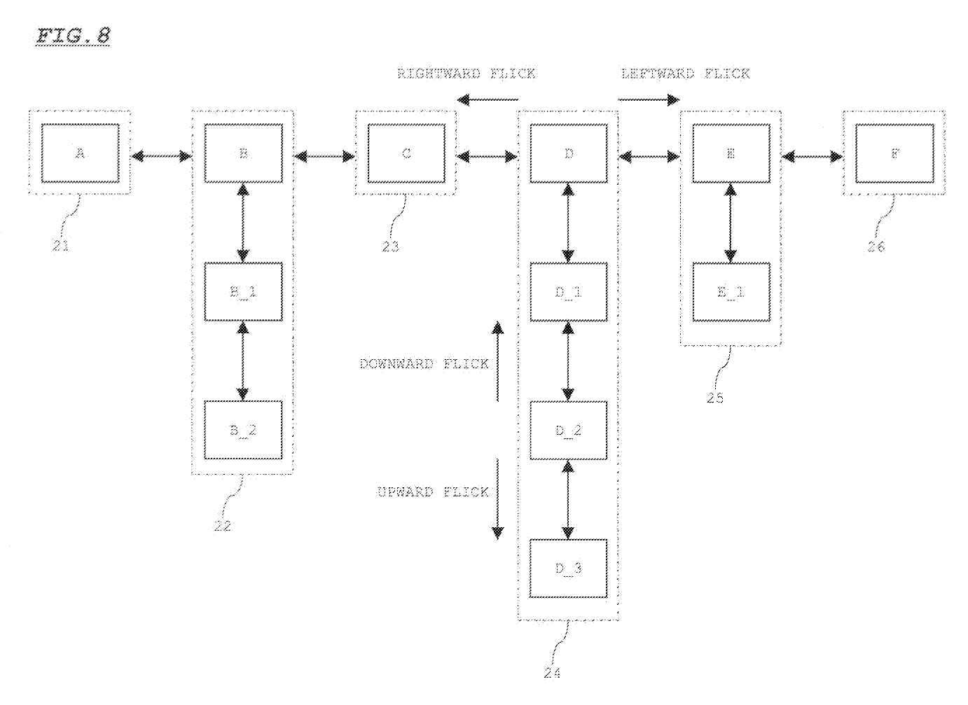

FIG. 8 is a diagram for describing relations between the directions of a flick performed as an operation for changing an image as a display target and images to be displayed by the transition from the flicked image. In FIG. 8, arrows connecting images or groups indicate relations between the directions of a flick and the transitions of images to be displayed on the display surface 11c.

Referring to FIGS. 7 and 8, the downward arrows indicate that, in response to detection of an upward flick by the touch sensor 12, the foregoing steps S131 to S133 are performed to cause a transition to display the next image on the display surface 11c. Similarly, the upward, rightward, and leftward arrows indicate that, in response to detection of a downward, leftward, or rightward flick by the touch sensor 12, transition takes place to display the previous image, the root image in the next group, or the root image in the previous group, respectively, on the display surface 11c.

The “upward flick” here is an operation performed by the user of contacting the touch panel by a finger and making a flick in the upward direction. Similarly, the “downward flick” here is an operation performed by the user of contacting the touch panel by a finger and making a flick in the downward direction. The “rightward flick” here is an operation performed by the user of contacting the touch panel by a finger and making a flick in the rightward direction. The “leftward flick” here is an operation performed by the user of contacting the touch panel by a finger and making a flick in the leftward direction.

Referring to FIGS. 7 and 8, when the touch sensor 12 detects an upward flick (S131: YES), in the case there exists the next image (S132: YES), the CPU 100 sets the next image as a display target (S133), and terminates the process of FIG. 7. In the case there exists no next image (S132: NO), the CPU 100 terminates the process of FIG. 7 without setting any image as a new display target.

Similarly, when the touch sensor 12 detects a downward flick (S134: YES), in the case there exists the previous image (S135: YES), the CPU 100 sets the previous image as a display target (S136), and terminates the process of FIG. 7. In the case there exists no previous image (S135: NO), the CPU 100 terminates the process of FIG. 7 without setting any image as a new display target.

In addition, when the touch sensor 12 detects a leftward flick (S137: YES), in the case there exists the next group (S138: YES), the CPU 100 sets the root image in the next group as a display target (S139), and terminates the process of FIG. 7. In the case there exists no next group (S138: NO), the CPU 100 terminates the process of FIG. 7 without setting any image as a new display target.

Further, when the touch sensor 12 detects a rightward flick (S137: NO), in the case there exists the previous group (S140: YES), the CPU 100 sets the root image in the previous group as a display target (S141), and terminates the process of FIG. 7. In the case there exists no previous group (S140: NO), the CPU 100 terminates the process of FIG. 7 without setting any image as a new display target.

As described above, in response to a rightward or leftward flick, an image other than the root image in the next or previous group may be shown, instead of the root image in the next or previous group.

For example, while the image D_{—}2 is displayed on the display surface 11c as shown in FIG. 6B, when the touch sensor 12 detects an upward, downward, leftward, or rightward flick, transition takes place from the image D_{—}2 to the image D_{—}3, D_{—}1, E, or C, according to the direction of the flick.

In addition, in the case there exists no image as a new display target based on the process of steps S132, S135, S138, and S140, the CPU 100 determines at step S117 to be performed after completion of the process of FIG. 7 (S116) that no change is made to the setting of the image as a display target (S117: NO).

Accordingly, even if a downward flick is performed while the image D as a first image of the D group 24 is displayed on display surface 11c, for example, the image displayed on the display surface 11c is not changed (S135: NO and S117: NO). In addition, even if an upward click is performed while the image D_{—}3 as a last image of the D group 24 is displayed on the display surface 11c, the image displayed on the display surface 11c is not changed (S132: NO and S117: NO).

Further, even if a rightward flick is performed while the image A of the A group 21 is displayed on display surface 11c, for example, the image displayed on the display surface 11c is not changed (S140: NO and S117: NO). In addition, even if a leftward click is performed while the image F of the F group 26 is displayed on the display surface 11c, the image displayed on the display surface 11c is not changed (S138: NO and S117: NO).

Returning to step S119 of FIG. 5, when the touch sensor 12 detects a predetermined end operation (for example, pressing of a predetermined key) (S119: YES), the CPU 100 terminates the process of FIG. 5. When the predetermined end operation is not performed (S119: NO), the process returns to step S114.

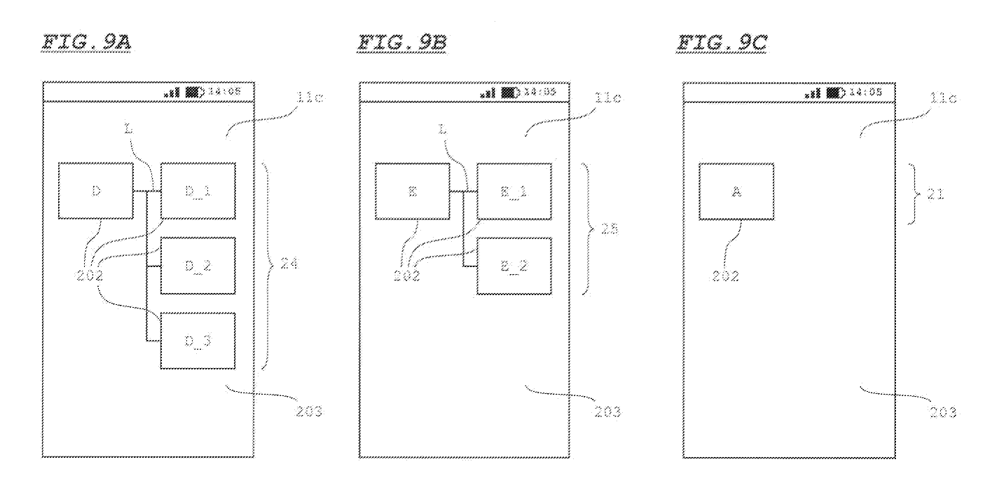

FIGS. 9A to 9C are diagrams showing a correlation chart screen 203 displayed on the display surface 11c according to the process of steps S114 and S120 to S122 of FIG. 5.

In the case it is determined at step S114 of FIG. 5 that an operation for switching the screens is performed, that is, that the button 204 is pressed (S114: YES), the CPU 100 displays the correlation chart screen 203 on the display surface 11c (S120). The correlation chart screen 203 includes thumbnails 202 of images in a group to which an image as a current display target belongs, in such a manner that relations between the root image as a source of editing and other images can be visibly recognized.

Specifically, the CPU 100 displays the thumbnail 202 of the root image on the left side of the display surface 11c, and displays the thumbnails 202 of the other images belonging to the group on the right side of the display surface 11c, and also displays a line L connecting the root image to the other images.

For example, when the button 204 is pressed (touched) while the image D_{—}2 (or any of the images D and D_{—}1 to D_{—}3 belonging to the D group 24) is displayed on the display surface 11c as shown in FIG. 6B, the CPU 100 displays the thumbnail 202 of the image D as root image of the D group on the left side of the display surface 11c, and displays the thumbnails 202 of the other images (the images D_{—}1 to D_{—}3) vertically arranged on the right side of the display surface 11c as shown in FIG. 9A. Further, the CPU 100 displays the line L branched in the form of a tree, to connect the thumbnail 202 of the image D as root image to the thumbnails 202 of the images D_{—}1 to D_{—}3 as child images.

Similarly, when the button 204 is pressed while any of the images belonging to the E group 25 is displayed on the display surface 11c, for example, the CPU 100 displays the thumbnails 202 of the images E, E_{—}1, and E_{—}2 belonging to the E group 25 on the display surface 11c, and connects the thumbnail 202 of the image E as root image to the thumbnail 202 of the other images E_{—}1 and E_{—}2, by the line L in the form of a tree, as shown in FIG. 9B.

When the button 204 is pressed while the image A is displayed on the display surface 11c, the thumbnail 202 of the image A is displayed on the correlation chart screen 203 because the A group 21 includes only the image A.

In the case only one image (root image) constitutes a group as in the case of the A group 21, the button 204 may not be displayed when the image A is displayed on the display surface 11c as described above.

While the correlation chart screen 203 is displayed as described above, when any of the images displayed on the display surface 11c is selected (when the thumbnail 202 of the image is tapped) (S121: YES), the CPU 100 sets the selected image as a display target (S122), and displays the selected image on the display surface 11c (S118).

As in the foregoing, according to the configuration of this embodiment, when the touch sensor 12 detects an upward or downward flick, transition of images displayed on the display surface 11c takes place between a root image and image(s) created from the root image. Accordingly, the user can easily identify a relation between a pre-editing image as a source of editing and post-editing image(s) created by editing the pre-editing image.

While a root image is displayed on the display surface 11c, when the touch sensor 12 detects an upward flick, an image newly created by editing the root image is displayed on the display surface 11c. In addition, while a post-editing image is displayed on the display surface 11c, when the touch sensor 12 detects a downward flick, a root image as a pre-editing image is displayed on the display surface 11c. The user can perform transitions of images displayed on the display surface 11c to view pre-editing and post-editing images in a size easy-to-see for the user, not in a small size of thumbnails.

Further, according to the configuration of this embodiment, it is possible to change the groups of images to be displayed on the display surface 11c by a rightward or leftward flick. This makes it possible to easily display image(s) belonging to a group different from a group to which an image as a current display target belongs.

Moreover, according to the configuration of this embodiment, when the button 204 is pressed, the correlation chart screen 203 is displayed on the display surface 11c. In the correlation chart screen 203, image(s) belonging to one group is displayed, and the line L indicating relations between a root image and other image(s) in the group is displayed. Accordingly, the user can recognize relations between the root image and the image(s) created by editing the root image, and grasp the entire configuration of the group.

### Modification Example 1

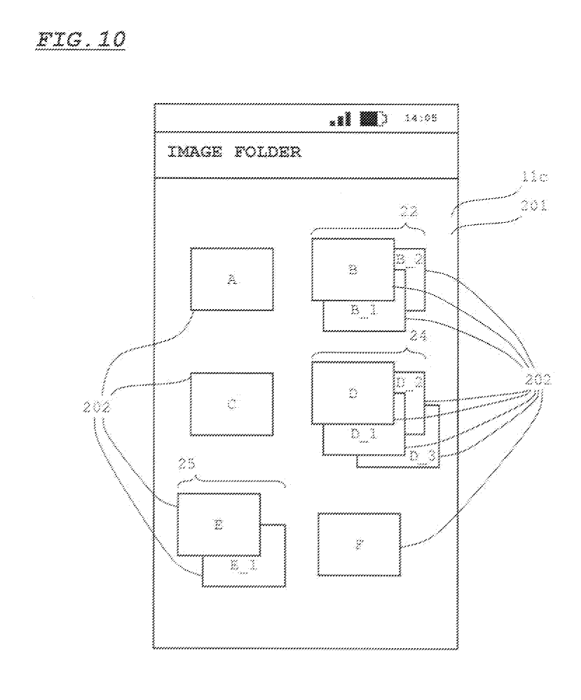

FIG. 10 is a diagram showing the list screen 201 for viewing a list of images stored in the image folder 20 according to modification example 1.

In the list screen 201 according to this modification example (refer to FIG. 10), the thumbnails 202 of the images stored in the image folder 20 are classified into the groups 21 to 26 and displayed on the display surface 11c. Specifically, the thumbnails 202 of images belonging to a group (for example, the B group 22) including a plurality of images are displayed in an overlapped state with predetermined displacement from one another. In addition, the thumbnails 202 of the images (B_{—}1 and B_{—}2) belonging to the group including a plurality of images are displayed in the overlapped state in the foregoing sequence (the images B, B_{—}1, and B_{—}2). Accordingly, the thumbnail 202 of the root image (B) is displayed in the overlapped state on the thumbnails 202 of the other images (B_{—}1 and B_{—}2). Further, the thumbnails 202 of the other images (B_{—}1 and B_{—}2) are displayed in the overlapped state with displacement from each other so that the user can recognize the images partly.

Similarly, the thumbnails 202 of the images D, D_{—}1, D_{—}2, and D_{—}3 belonging to the D group 24 are displayed in the overlapped state with predetermined displacement from one another. In addition, the thumbnails 202 of the images E and E_{—}1 belonging to the E group 25 are displayed in the overlapped state with displacement from each other.

At step S112 of FIG. 5 according to this modification example, when an operation for selecting (tapping) the thumbnails 202 in one group including a plurality of images is performed, the CPU 100 determines that the root image of the group is selected by the operation (S112: YES). Therefore, at step S113, the CPU 100 sets the root image determined as being selected, as a display target, and displays the root image on the display surface 11c.

As in the foregoing, according to the configuration of this modification example, the user can view the list screen 201 to easily recognize relations between root images as pre-editing images and images created by editing the root images.

### Modification Example 2

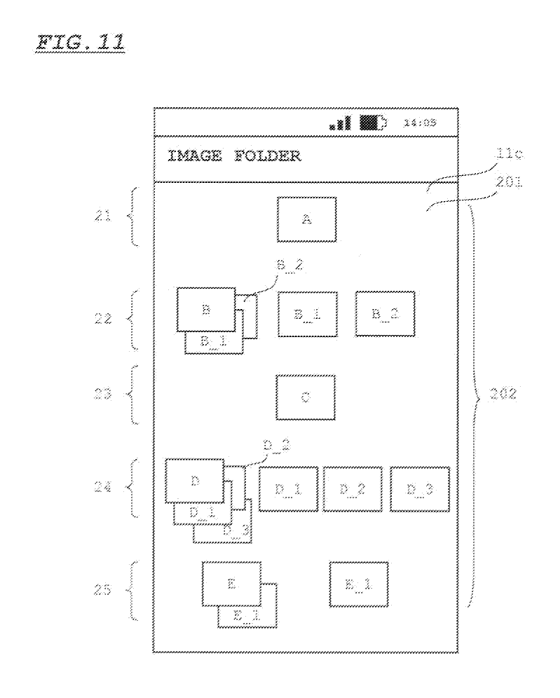

FIG. 11 is a diagram showing the list screen 201 according to modification example 2.

In the list screen 201 (refer to FIG. 11) according to this modification example, the thumbnails 202 of the images stored in the image folder 20 are classified into the groups 21 to 25 and aligned from top down on the display surface 11c.

Specifically, the thumbnails 202 of images belonging to a group including a plurality of images are displayed in the overlapped state with displacement from one another, as in modification example 1. Further, according to this modification example, in each of the groups (for example, the B group 22), the thumbnails 202 of the images (B_{—}1 and B_{—}2) other than the root image (image B) are further individually displayed on the display surface 11c, separately from the foregoing overlapped thumbnails, as shown in FIG. 11.

Similarly, the thumbnails 202 of the images D_{—}1, D_{—}2, and D_{—}3 other than the image D as root image in the D group 24 are further individually displayed on the display surface 11c, separately from the foregoing overlapped thumbnails. In addition, the thumbnail 202 of the image E_{—}1 other than the image E as root image in the E group 25 is further individually displayed on the display surface 11c, separately from the foregoing overlapped thumbnails.

At step S112 of FIG. 5 according to this modification example, when an operation for selecting (tapping) the thumbnails 202 in one group including a plurality of images is performed, the CPU 100 determines that the root image is selected by the operation, as in modification example 1 (S112: YES). In addition, when an individual image is selected in the list screen 201, for example, when the image B_{—}1 is selected, the CPU 100 determines that the image B_{—}1 is selected by the operation (S112: YES).

As in the foregoing, according to the configuration of this modification example, the thumbnails 202 of images other than root images are entirely displayed on the list screen 201. Accordingly, the user can recognize relations between images as sources of editing and post-editing images in the list screen 201, and can view the thumbnails 202 not hidden in part, that is, viewable as a whole, thereby to easily grasp the overview of the images.

### Modification Example 3

In the foregoing embodiment, it is possible to identify root images and images created by editing the root images. However, in the foregoing embodiment, it is not possible in some cases to identify images directly created from root images or post-editing images, or images as direct sources of editing from which post-editing images are created. For example, in the foregoing embodiment, it is not possible to identify which of the images D, D_{—}1, and D_{—}2 belonging to the D group 24 is an image as a direct source of editing from which the image D_{—}3 is created as described above with reference to FIG. 4B. Since the image D_{—}3 may be created directly from the image D_{—}1 or D_{—}2, it is not possible to determine that the image D_{—}3 is created directly from the image D as root image.

Meanwhile, in modification example 3, it is possible to identify images as direct sources of editing and directly created images.

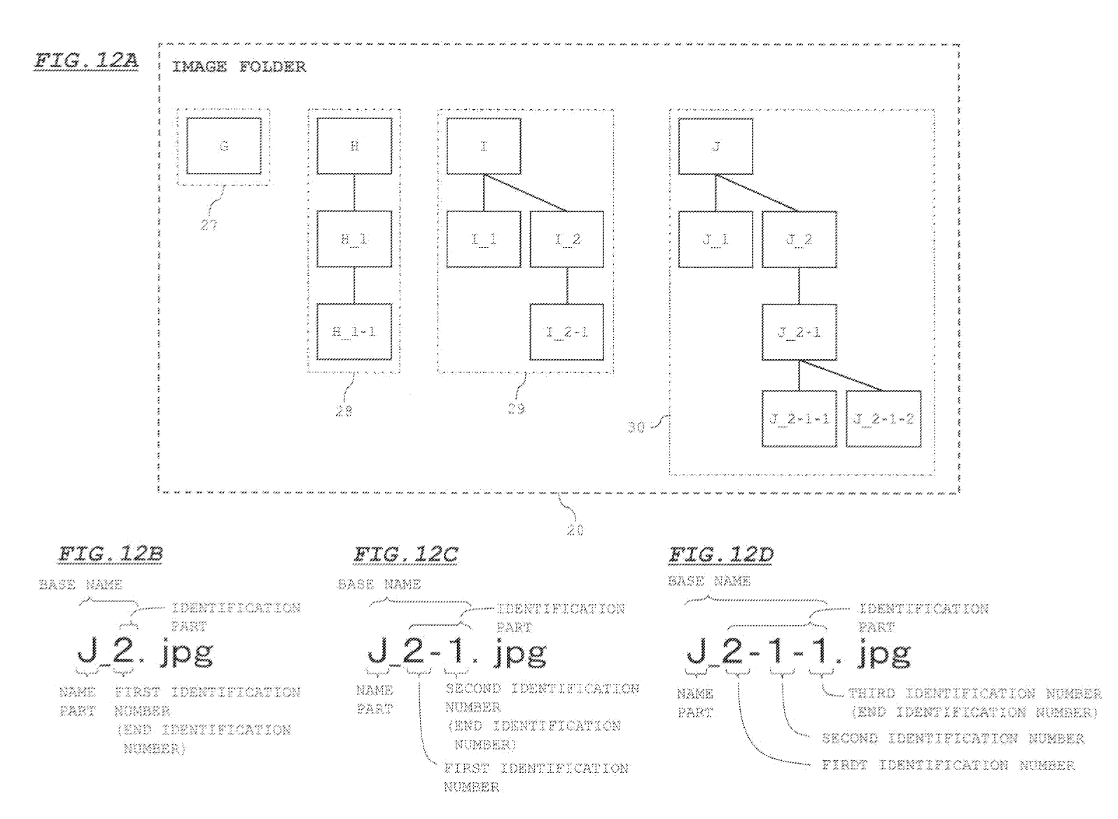

FIG. 12A is a diagram showing one example of images stored in the image folder 20 according to this modification example. In FIG. 12A, the image folder 20 stores 14 images G, H, H_{—}1, H_{—}1-1, I, I_{—}1, I_{—}2, I_{—}2-1, J, J_{—}1, J_{—}2, J_{—}2-1, J_{—}2-1-1, and J_{—}2-1-2. The 14 images are stored in the image folder 20, under the filenames G.jpg, H.jpg, H_{—}1.jpg, H_{—}1-1.jpg, I.jpg, I_{—}1.jpg, I_{—}2.jpg, I_{—}2-1.jpg, J.jpg, J_{—}1.jpg, J_{—}2.jpg, J_{—}2-1.jpg, J_{—}2-1-1.jpg, and J_{—}2-1-2.jpg, respectively.

FIGS. 12B to 12D are diagrams for describing the structures of file names of images according to this modification example.

Base name (the part other than the period and the extension “.jpg”) of the file name of each of the 14 images stored in the image folder 20 may include one underline “_”. Each of the base names is divided into the “name part” before the underline “_” and the “identification part” after the underline “_”. In the case any of the base names does not include the underline “_”, the entire base name constitutes the name part.

Each of the identification parts is formed by one identification number (first identification number) or a plurality of identification numbers (first identification number, second identification number, . . . ). In the case of an identification part formed by a plurality of identification numbers, the identification numbers are connected together with hyphen “-.”

The file name “J_{—}2.jpg” shown in FIG. 12B has the name part “J” and the identification part formed by the first identification number “2”. The filename “J_{—}2-1.jpg” shown in FIG. 12C has the name part “J” and the identification part formed by the first identification number “2” and the second identification number “1”. The file name “J_{—}2-1-1.jpg” shown in FIG. 12D has the name part “J” and the identification part formed by the first identification number “2”, the second identification number “1”, and the third identification number “1.”

An “end identification number” is an identification number at the end of the identification part, that is, an identification number immediately before the period “.”. For example, the file names shown in FIGS. 12B to 12D have as the end identification numbers, the first identification number “2”, the second identification number “1”, and the third identification number “1”, respectively.

As in the foregoing embodiment, the images stored in the image folder 20 can be classified by name part and identification part. The 14 images shown in FIG. 12A are classified into G group 27, H group 28, I group 29, and J group 30.

As shown in FIG. 12A, the G group 27 is formed by only the image G. The H group 28 is formed by the images H, H_{—}1, and H_{—}1-1. The I group 29 is formed by the images I, I_{—}1, I_{—}2, and I_{—}2-1. The J group 30 is formed by the images J, J_{—}1, J_{—}2, J_{—}2-1, J_{—}2-1-1, and J_{—}2-1-2.

Each of the groups 27 to 30 includes one root image, that is, one image with a file name not containing an identification number.

In FIG. 12A, each of lines connecting two images shows a relation between the images. For example, the lines connecting the image I and the images I_{—}1 and I_{—}2 indicate that the images I_{—}1 and I_{—}2 are created directly from the image I. The line connecting the image I_{—}2 and the image I_{—}2-1 indicates that the image I_{—}2-1 is created directly from the image I_{—}2.

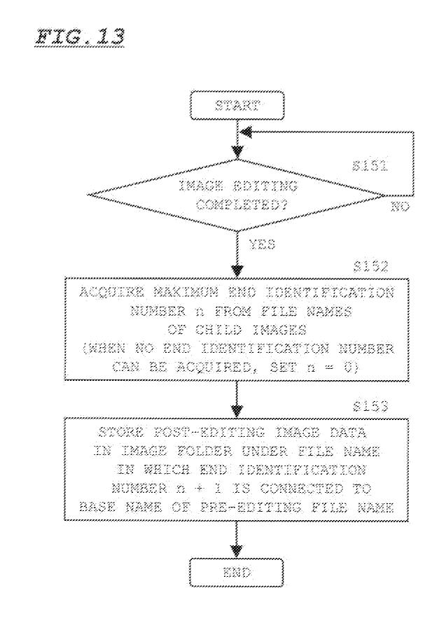

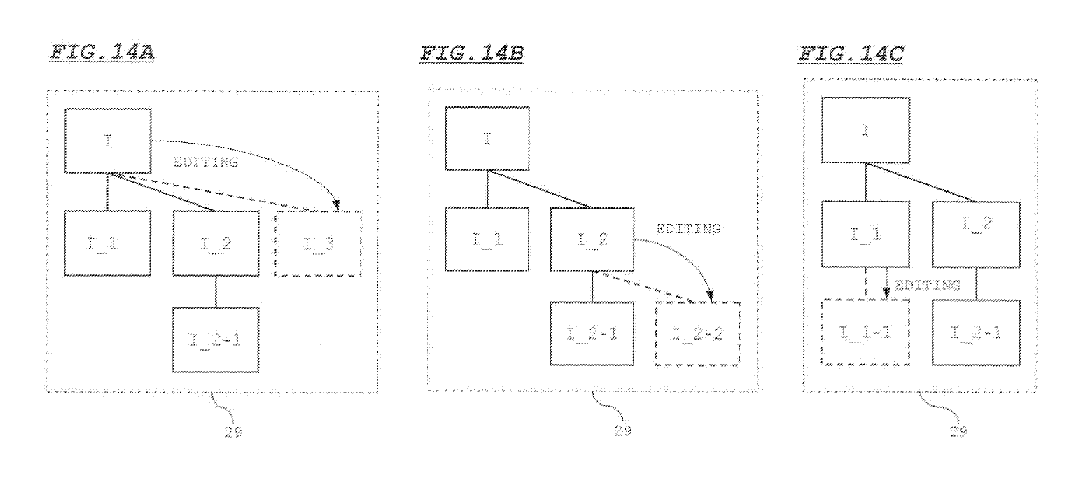

FIG. 13 is a flowchart showing a process for storing a post-editing image created by editing an image stored in the image folder 20, under a predetermined file name. The flowchart of FIG. 13 corresponds to the flowchart shown in FIG. 4A in the foregoing embodiment. FIGS. 14A to 14C are diagrams showing examples of additions of new images to the image folder 20 according to the process of FIG. 13.

In the flowchart of FIG. 13, when editing of an image is completed (S151: YES), the CPU 100 acquires a maximum end identification number n from the file name (s) of existing child image(s) of the image as an editing target (S152). In the case no end identification number can be obtained, that is, in the case the image as an editing target has no child image, the CPU 100 sets n=0 (S152).

The “child image” of the image as an editing target is an image created directly from the image as an editing target, and the child image has a file name in which one more identification number is added to the identification part of the file name of the image as an editing target. For example, the image J_{—}2 is a child image of the image J, the image J_{—}2-1 is a child image of the image J_{—}2, and the image J_{—}2-1-1 is a child image of the image J_{—}2-1.

After step S152, the CPU 100 stores the post-editing image in the image folder 20, under a file name in which the end identification number n+1 is connected to the base name of the file name of the pre-editing image, with the underline “_” or the hyphen “-” (S153).

For example, in the case the image I as a root image is edited, the maximum end identification number acquired at step S152 is n=2. Therefore, the post-editing image (in the jpg format, for example) is stored in the image folder 20 under the file name “I_{—}3.jpg” as shown in FIG. 14A. Accordingly, the image I_{—}3 is newly added to the I group 29.

Similarly, the file name of an image newly created by editing the image I_{—}2, for example, is “I_{—}2-2.jpg” as shown in FIG. 14B. In addition, the file name of an image newly created by editing the image I_{—}1 is “I_{—}1-1.jpg” as shown in FIG. 14C.

Accordingly, when a certain file name is specified according to the process of FIG. 13, data of an image as an editing target and a child image thereof, and data (relation data) indicative of a relation between these images are stored in the memory 101.

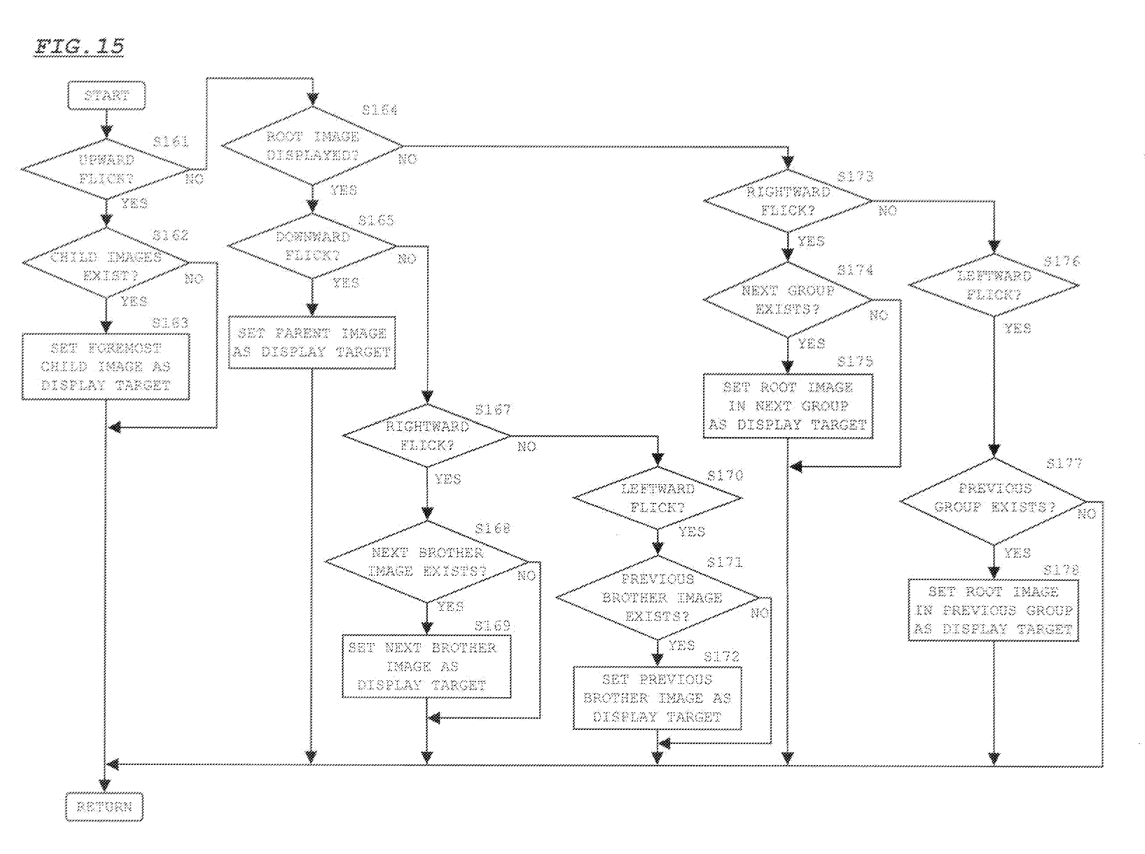

FIG. 15 is a flowchart showing contents of a process for setting an image as a display target at step S116 of FIG. 5 according to the modification example. In this modification example, data indicative of a relation between a parent image and a child image can be used to view these images in such a manner that a parent-child relation between the images can be recognized. At that time, a process for viewing the images similar to the process shown in FIG. 5, is performed. The “parent image” here refers to an image as a direct editing source of a child image. For example, the parent image of the image J_{—}2 is the image J. The image J has no parent image.

The flowchart of FIG. 15 shows a process for, with reference to an image as a current display target, setting as display targets the child image, the parent image, the next brother image, the previous brother image, the root image in the next group, or the root image in the previous group, according to the direction of a flick (upward, downward, leftward, or rightward).

The “brother images” here refer to images having a common parent image. For example, the images I_{—}1, I_{—}2, and I_{—}3 are brother images having the image I as a common parent image. The “next brother image” and the “previous brother image” here each refer to an image having a file name in which one is added to or subtracted from the end identification number of the file name of the image as a current display target. For example, the next brother image of the image I_{—}2 is I_{—}3, and the previous brother image of the image I_{—}2 is I_{—}1.

In the flowchart of FIG. 15, when the touch sensor 12 detects un upward flick (S161: YES), in the case the image as a current display target has child images (S162: YES), the CPU 100 sets the foremost one of the child images, that is, the child image with the smallest end identification number as a display target (S163), and terminates the process of FIG. 15. In the case the image as a current display target has no child image (S162: NO), the CPU 100 terminates the process of FIG. 15.

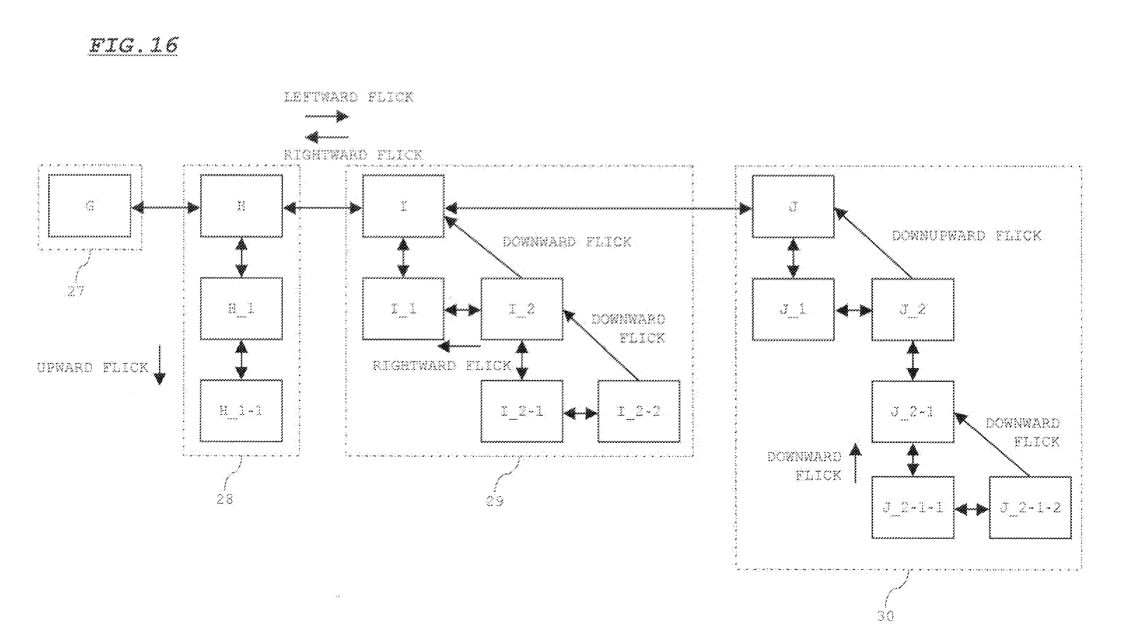

FIG. 16 is a diagram for describing transitions of images displayed on the display surface 11c according to the process of FIG. 15. In FIG. 16, arrows connecting images or groups represent relations between the directions of a flick and transitions of images displayed on the display surface 11c. In FIG. 16, the downward arrow corresponds to a direction in which a transition of images displayed on the display surface 11c takes place in response to detection of an upward flick by the touch sensor 12. For example, while the image I_{—}2 is displayed on the display surface 11c, when the touch sensor 12 detects an upward flick, the image I_{—}2-1 is displayed on the display surface 11c, in place of the image I_{—}2.

Returning to FIG. 15, in the case the flick detected by the touch sensor 12 is not an upward flick (S161: NO), the CPU 100 determines whether the image as a display target is a root image (S164). In the case the image as a display target is not a root image (S164: NO), the CPU 100 then determines whether the touch sensor 12 has detected a downward flick, a leftward flick, or a rightward flick (S165, S167, and S170).

When the touch sensor 12 detects a downward flick (S165: YES), the CPU 100 sets a parent image of the image as a current display target, as a new display target (S166), and then terminates the process of FIG. 15.

In addition, in the case the touch sensor 12 detects a leftward flick (S167: YES), when there exists a next brother image (S168: YES), the CPU 100 sets the next brother image as a display target (S169), and then terminates the process of FIG. 15. In the case there exists no next brother image (S168: NO), the CPU 100 terminates the process of FIG. 15.

Further, in the case the touch sensor 12 detects a rightward flick (S170: YES), when there exists a previous brother image (S171: YES), the CPU 100 sets the previous brother image as a display target (S172), and then terminates the process of FIG. 15. In the case there exists no previous brother image (S171: NO), the CPU 100 terminates the process of FIG. 15.

Meanwhile, when it is determined at step S164 that the root image is a display target (S164: YES), the CPU 100 determines whether the touch sensor 12 has detected a leftward flick or a rightward flick (S173 and S176).

In the case the touch sensor 12 detects a leftward flick (S173: YES), when there exists a next group (S174: YES), the CPU 100 sets the root image in the next group as a display target (S175), and then terminates the process of FIG. 15. In the case there exists no next group (S174: NO), the CPU 100 terminates the process of FIG. 15.

In addition, in the case the touch sensor 12 detects a rightward flick (S176: YES), when there exists a previous group (S177: YES), the CPU 100 sets the root image in the previous group as a display target (S178), and then terminates the process of FIG. 5. In the case there exists no previous group (S177: NO), the CPU 100 terminates the process of FIG. 15.

Referring to FIG. 16, while the image I_{—}2 is displayed on the display surface 11c, for example, when the touch sensor 12 detects a rightward flick (see a leftward arrow in FIG. 16), a transition takes place to display the image I_{—}1 as the previous brother image on the display surface 11c. In addition, when the touch sensor 12 detects a downward flick (refer to an obliquely upward and leftward arrow in FIG. 16), a transition of images displayed on the display surface 11c takes place to the image I as the parent image. Since there exists no next brother image of the image I_{—}2, even if a leftward flick is performed while the image I_{—}2 is displayed, the image as a display target is not changed.

As in the foregoing, according to the configuration of this modification example, while an image other than the root image is displayed on the display surface 11c, when the touch sensor 12 detects a rightward or leftward flick, the root image in the previous or next group is not displayed but the brother image is displayed, unlike the foregoing embodiment. In addition, while a root image is displayed on the display surface 11c, when the touch sensor 12 detects a rightward or leftward flick, the root image in the previous or next group is displayed as in the foregoing embodiment.

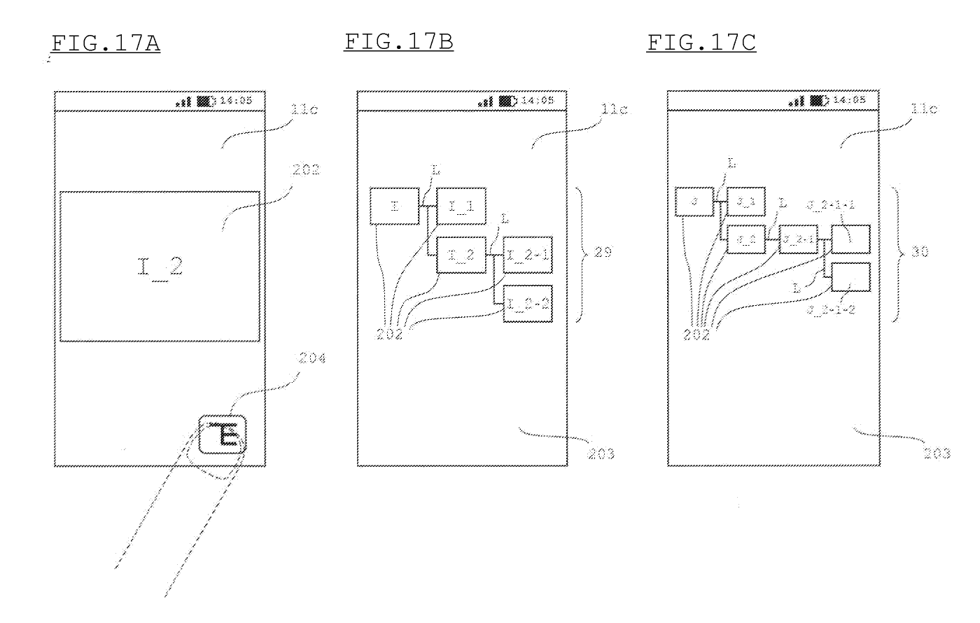

FIGS. 17A to 17C are diagrams showing screens on the display surface 11c at execution of steps S114 and S120 to S122 of FIG. 15.

For example, while the image I_{—}2 is displayed on the display surface 11c as shown in FIG. 17A, when the button 204 is pressed (S114: YES), the CPU 100 displays the correlation chart screen 203 for the group on the display surface 11c (S120).

In the correlation chart screen 203, the CPU 100 shows the thumbnails 202 of the images I, I_{—}1, I_{—}2, I_{—}2-1, and I_{—}2-2 in the I group 29 on the display surface 11c, and displays the line L branched in the form of a tree to connect parent and child images as shown in FIG. 17B, so that the user can visibly check the relations between the parent and child images.

FIG. 17C shows the correlation chart screen 203 for the J group 30. In the correlation chart screen 203, the CPU 100 displays the thumbnails 202 of the images J, J_{—}1, J_{—}2, J_{—}2-1, J_{—}2-1-1, and J_{—}2-1-2 in the J group 30 on the display surface 11c, and displays the line L branched in the form of a tree to connect parent and child images so that the user can visibly check the relations between the parent and child images.

As in the foregoing, according to the configuration of this modification example, while an image stored in the image folder 20 is displayed on the display surface 11c, when the touch sensor 12 detects a downward flick, the parent image of the currently displayed image is then displayed. When the touch sensor 12 detects an upward flick, the child image of the currently displayed image is then displayed (refer to FIG. 16). Accordingly, the user can easily identify an image as a direct source of editing, image(s) created by direct editing, and the relations between these images.

In addition, according to the configuration of this modification example, while a child image is displayed, when the touch sensor 12 detects a rightward or leftward flick, the brother image of the child image is displayed. Accordingly, the user can easily identify a relation between the image as a current display target and the brother image thereof.

Further, according to the configuration of this modification example, in the correlation chart screen 203, the thumbnails 202 of images belonging to a group are displayed in the list, and the line L representing direct relations between pre-editing and post-editing images is displayed. Accordingly, the user can recognize the direct relations between the pre-editing and post-editing images, and grasp the entire configuration of the group.

### Modification Example 4

In modification example 3, according to the file names of the images stored in the image folder 20, the brother image is displayed in response to a rightward or leftward flick, and the parent and child images are displayed in response to an upward or downward flick. However, even in the case the file names of the images are specified in the same manner as in modification example 3, all of images in one group may be viewed in response to an upward or downward flick as in the foregoing embodiment.

However, the “next image” at steps S132 and S133 and the “previous image” at step S135 and S136 of FIG. 7 according to this modification example are specified as described below.

Referring to FIG. I_{—}2, the CPU 100 specifies a sequence (alignment sequence) in which the images stored in the image folder 20 are aligned, based on the relations between the parent and child images in each of the groups.

In one group, when two images are in a relation of parent and child images, the parent image comes earlier than the child image. When two images are in a relation of brother images, the CPU 100 specifies the sequence of the two images according to the end identification numbers.

For example, the alignment sequence in the H group 28 (FIG. 12A) is specified as H, H_{—}1, and H_{—}1-1. The alignment sequence in the I group 29 is specified as I, I_{—}1, I_{—}2, and I_{—}2-1. The alignment sequence in the J group 30 is specified as J, J_{—}1, J_{—}2, J_{—}2-1, J_{—}2-1-1, and J_{—}2-1-2.

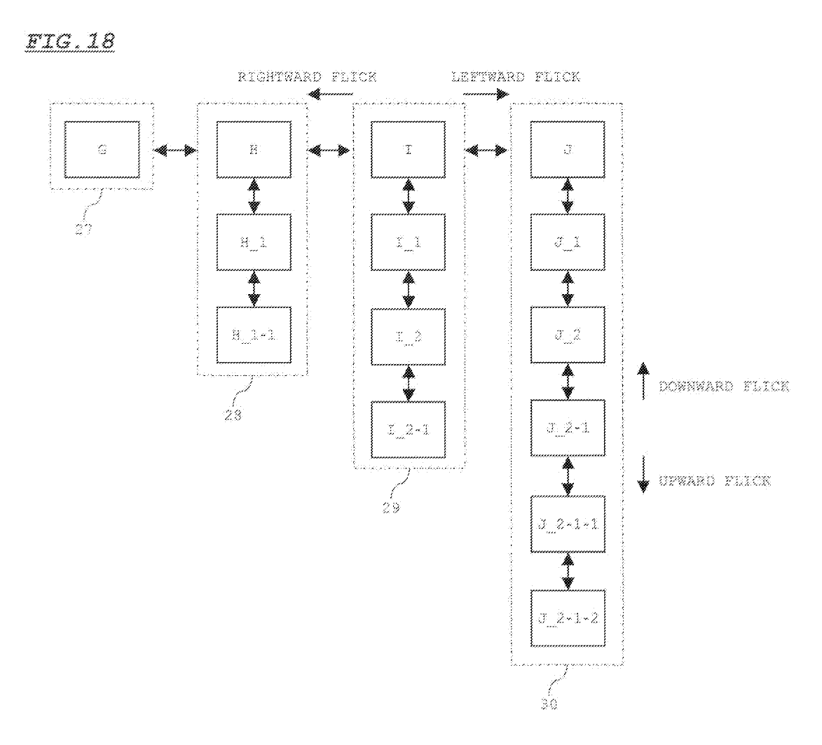

FIG. 18 is a diagram for describing transitions of image displayed on the display surface 11c based on the process of FIG. 7, according to this modification example. FIG. 18 corresponds to the diagram of transition of the image of FIG. 8 according to the foregoing embodiment.

According to FIG. 18, when the touch sensor 12 detects an upward flick, a transition of images displayed on the display surface 11c takes place to the “next image” according to the alignment sequence specified as described above. Similarly, when a downward flick is performed, a transition of images displayed on the display surface 11c takes place to the “previous image” according to the alignment sequence specified as described above. For example, while the image J_{—}2-1 is displayed on the display surface 11c, when the touch sensor 12 detects an upward or downward flick, a transition takes place to the image J_{—}2-1-1 or J_{—}2.

As in the foregoing, according to the configuration of this modification example, a transition of images displayed on the display surface 11c takes place from a root image to descendent images such as a child image and a grand-child image (a child image of the child image), or from descendent images to a root image.

### Others

As in the foregoing, the embodiment is described. However, the present invention is not limited to the foregoing embodiment, and the embodiment of the present invention can be modified in various manners other than the foregoing ones.

In the foregoing embodiment and modification examples 1 to 4, of the images stored in the image folder 20, an image as a display target is displayed on the display surface 11c as a major constituent element of a screen, based on the process of step S113 or S118. When the image as a display target is displayed on the display surface 11c, the other images stored in the image folder 20 (parent image, root image(s), brother image(s), child image(s), image(s) belonging to other groups, and the like) may be further displayed on the display surface 11c.

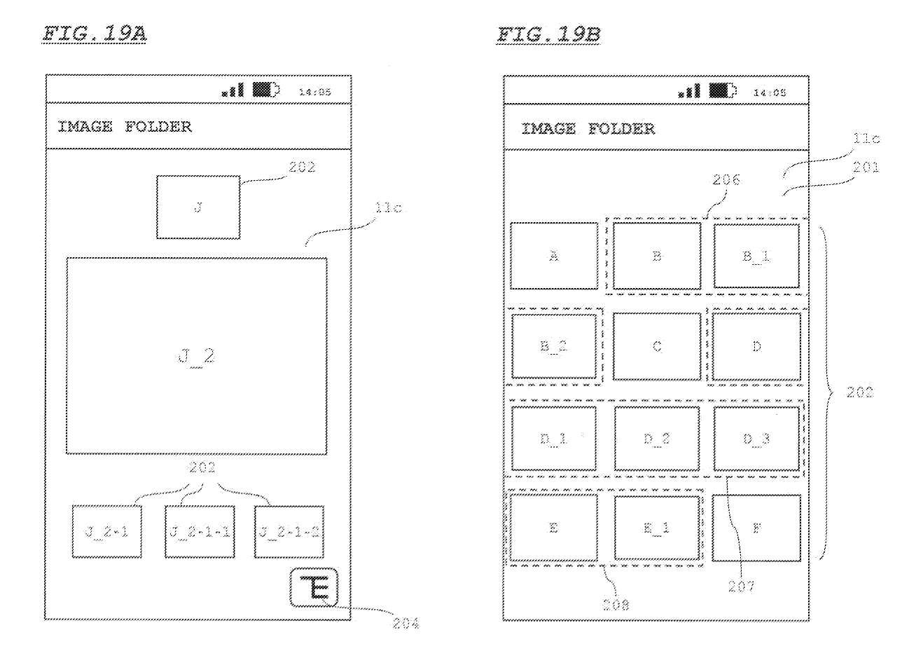

For example, as shown in FIG. 19A, while the image J_{—}2 set as a current display target is displayed on the display surface 11c as a major constituent element of the screen, the image J as the parent image of the image J_{—}2 may be further displayed at a part of the display surface 11c (for example, above the image J_{—}2).

In addition, as shown in FIG. 19A, while the image J_{—}2 as a current display target is displayed on the display surface 11c as a major constituent element of the screen, for example, the descendent images J_{—}2-1, J_{—}2-1-1, and J_{—}2-1-2 of the image J_{—}2 may be further displayed on a part of the display screen 11c (for example, under the image J_{—}2).

When the configuration shown in FIG. 19A is employed, the image(s) to be displayed on the display surface 11c as major constituent elements of the screen according to the direction of a flick, are already displayed (in a reduced state) on the upper and lower sides of the display surface 11c. Accordingly, the user can easily grasp the overview of the images in relation to the image (J_{—}2) currently displayed.

In the foregoing embodiment, while the image of the A group 21 (or the F group 26) is displayed on the display surface 11c, even if a rightward flick (a leftward flick in the case of the F group 26) is performed, any image in the other groups is not displayed on the display surface 11c. Alternatively, images in all of the groups may be displayed in turn according to a rightward or leftward flick, for example. Specifically, while the image of the A group 21 is displayed, when the touch sensor 12 detects a rightward flick, the image of the F group 26 (for example, the image F as root image) may be displayed. In contrast, while the image of the F group 26 is displayed, when the touch sensor 12 detects a leftward flick, the image of the A group 21 (for example, the image A as root image) may be displayed. Such a configuration can also be applied to modification examples 1 to 4.

In the foregoing embodiment, even if a downward flick is performed while a root image is displayed on the display surface 11c, no transition of images displayed on the display surface 11c takes place. Alternatively, images in all of the groups may be displayed in turn according to an upward or downward flick, for example. Specifically, when the touch sensor 12 detects a downward flick while the root image is displayed, a transition may take place to the last image in the group. When the touch sensor 12 detects an upward flick while the last image is displayed, the root image may be displayed. Such a configuration can also be applied to modification examples 1 to 4.

In modification examples 1 and 2, when the list screen 201 of FIGS. 10 and 11 is displayed on the display surface 11c, the pre-editing and post-editing images are related to one another. Alternatively, the pre-editing and post-editing images may be related to one another in other various manners, for example, in such a manner that, when the thumbnails 202 of the images are displayed on the list screen 201, the list screen 201 of FIG. 19B is shown on the display surface 11c. The list screen 201 of FIG. 19B is formed such that dotted-line frames 206, 207, and 208 for defining groups are added to the list screen 201 of FIG. 6. The dotted-line frames 206, 207, and 208 indicate the B group 22, the D group 24, and the E group 25. In each of the dotted-line frames 206, 207, and 208, the thumbnail 202 of the root image of the group comes first. The user can visually check the dotted-line frames 206 and 207 and the thumbnails 202 within these frames to recognize relations between the root images as pre-editing images and other images created by editing the root images.

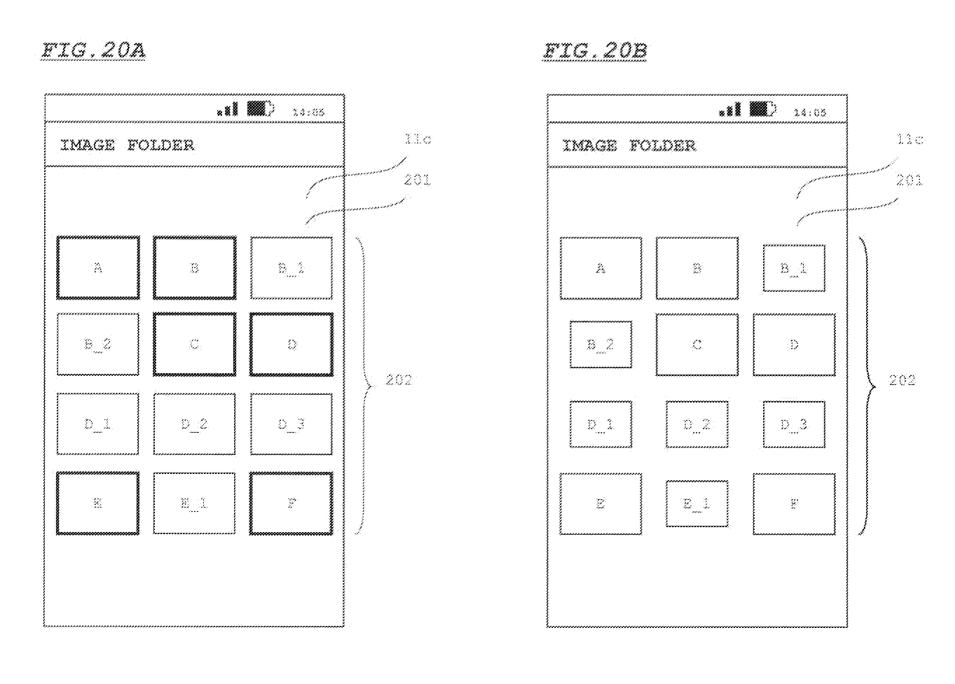

In addition, as shown in FIG. 20A, the thumbnails 202 of the images A to F as root images may be made remarkable by providing frames surrounding the thumbnails 202, thereby notifying the user of the existence of the root images. Displayed subsequent to the thumbnails 202 of the root images are the thumbnails 202 of the images created from the root images. Alternatively, as shown in FIG. 20B, the thumbnails 202 of the images other than the root images may be displayed in a smaller size as compared to the normal size. In the display form, the user can also visually check relations between the root images as pre-editing images and other images created by editing the root images.

In the foregoing embodiment and modification examples 1 to 4, when the touch sensor 12 detects a predetermined operation (a rightward or leftward flick), images in another group are displayed. Alternatively, after an image is selected in the list screen 201 and the selected image is displayed on the display surface 11c, no images in another group may be displayed. For example, in the configuration of the foregoing embodiment, rightward and leftward flicks (refer to FIG. 8) may be disabled.

In addition, in the foregoing embodiment and modification examples 1, 2, and 4, a root image in another group is displayed according to a predetermined operation (a rightward or leftward flick). Alternatively, a root image in another group may be displayed or not be displayed, depending on the image as a current display target. For example, in the case the image as a current display target is not a root image, steps S139 and S141 of FIG. 7 may be skipped so that a root image in another group is not displayed.

Alternatively, it may be determined whether to perform a transition to an image in another group by a rightward or leftward flick in the screen of FIG. 6B, depending on which of the thumbnails 202 is selected in the list screen 201 in modification example 2 (refer to FIG. 11). For example, in the case the thumbnails 202 of overlapped images are selected in the list screen 201 of FIG. 11, a transition to an image in another group may be inhibited even if a rightward or leftward flick is performed after the root image is displayed on the display surface 11c. In this case, a transition is enabled only within a group by performing a flick.

In the foregoing embodiment and modification examples 1 to 4, pre-editing images (root images and parent images) and post-editing images (images other than the root images, child images and grand-child images) are related to one another, according to the identification numbers of the file names of the images. Such relations may not necessarily be given by the identification numbers as described above but may be given by other various forms. For example, a predetermined file or database for defining the relations may be configured and stored in the memory 101. For example, a file including data for identifying child images of each image may be created to define the foregoing relations.

In the foregoing embodiment and modification examples 1 to 4, when a predetermined operation (flick) as input to the display surface 11c including the touch sensor 12 is detected, a transition of images displayed on the display surface 11c takes place (FIGS. 8, 16, and 18). However, the relations between the predetermined operations and the image transitions described above for the foregoing embodiment and modification examples 1 to 4 are merely examples, and the relations may be changed according to the input detection means included in the cellular phone 1, the use application of the cellular phone 1, or the like. For example, transitions may take place between pre-editing and post-editing images, according to a predetermined operation as input to hardware key(s) included in the cellular phone 1.

When images are displayed on the display surface 11c and an application is executed for a slide show in which automatic transitions of images displayed on the display surface 11c take place sequentially, only root images may be displayed in the slide show. Accordingly, the user can easily view only the pre-editing images (root images and parent images) in sequence. Even if a large number of images are stored in the image folder 20, for example, the user can easily view only the pre-editing images (root images and parent images).

In the forgoing embodiment, the present invention is applied to a smart phone. However, not limited to this, the present invention is also applied to other types of cellular phones such as a straight type, a folding type, and a slide type.

Further, the present invention is not limited to cellular phones, but can be applied to various kinds of communications device including mobile terminal devices such as personal digital assistants, tablet PCs, and electronic book terminals.

Besides, the embodiment of the present invention can be modified as appropriate in various manners within the scope of technical ideas disclosed in the claims.

What is claimed is:

1. A mobile terminal device, comprising:
a display surface;
a storage module which stores data of a first image, data of a second image created from the first image, and relation data for relating the first image to the second image; and
a display control module which displays on the display surface the first image and the second image in a form indicating that these images relate to each other.

2. The mobile terminal device according to claim 1, further comprising:
an operation detection module which detects a predetermined operation, wherein
the display control module allows a transition of images displayed on the display surface to take place between the first image and the second image according to the predetermined operation.

3. The mobile terminal device according to claim 2, wherein
the storage module stores a third image having no relation with the first image based on the relation data,
the operation detection module detects other operation than the predetermined operation, and
the display control part allows a transition of images displayed on the display surface to take place between the first or second image and the third image according to the other operation.

4. The mobile terminal device according to claim 1, wherein
the display control module displays a screen including the reduced first image and the reduced second image on the display surface, in a form indicating that the first image and the second image relate to each other.

5. The mobile terminal device according to claim 4, wherein
the display control module displays a list screen including the reduced first image and the reduced second image on the display surface, in a manner that the reduced first image and the reduced second image are partly overlapped.

6. A storage medium holding a computer program, wherein
the computer program provides a computer of a mobile terminal device comprising a display surface which displays an image, with a function of displaying on the display surface a first image and a second image created from the first image in a form indicating that these images relate to each other.

7. A method for display control of a mobile terminal device including a display surface and a storage module, comprising the steps of:
storing data of a first image, data of a second image created from the first image, and data for relating the first image to the second image, in the storage module; and
displaying on the display surface the first image and the second image in a form indicating that these images relate to each other.
